(19) United States
(12) Patent Application Publication
(10) Pub. No.: US 2025/0199963 A1
(43) Pub. Date: Jun. 19, 2025

(54) MEMORY ACCESS METHOD AND INPUT/OUTPUT MEMORY MANAGEMENT UNIT

(71) Applicant: CLOUD INTELLIGENCE ASSETS HOLDING (SINGAPORE) PRIVATE LIMITED, SINGAPORE (SG)

(72) Inventors: Kaijie GUO, Zhejiang (CN); Ben LUO, Shanghai (CN); Kaihuan PENG, Zhejiang (CN)

(73) Assignee: CLOUD INTELLIGENCE ASSETS HOLDING (SINGAPORE) PRIVATE LIMITED, SINGAPORE (SG)

(21) Appl. No.: 18/842,859

(22) PCT Filed: Feb. 13, 2023
(86) PCT No.: PCT/CN2023/075640

§ 371 Date: Aug. 30, 2024

(30) Foreign Application Priority Data
Mar. 2, 2022 (CN) 202210200147.X

(51) Int. Cl. G06F 12/1027; G06F 12/0831; G06F 12/1009

(52) U.S. Cl. CPC G06F 12/1027; G06F 12/0831; G06F 12/1009

(57) ABSTRACT

A memory access method and an input-output memory management unit (IOMMU) are disclosed. The method includes: receiving a memory access request sent by a PCI device, which carrying a virtual address; searching for a physical address corresponding to the virtual address in its IOTLB; in a case that no corresponding physical address is found, broadcasting an address probing message carrying the virtual address to each CPU core; searching for a physical address corresponding to the virtual address in its TLB in response to the address probing message, and sending an address response message carrying the found physical address to the IOMMU after finding the physical address corresponding to the virtual address; and receiving, by the IOMMU, the address response message sent by the CPU core, storing a mapping relationship between the physical address and the virtual address in its IOTLB, and performing memory access based on the physical address.

### CROSS-REFERENCE TO RELATED APPLICATIONS

The present application claims priority to the Chinese patent application No. 202210200147.X filed with the China Patent Office on Mar. 2, 2022, entitled “Memory Access Method and Apparatus, and Input-Output Memory Management Unit”, which is incorporated by reference in the present application in its entirety.

### TECHNICAL FIELD

The present specification relates to the technical field of computers, and in particular to a memory access method and apparatus, and input/output memory management unit.

### BACKGROUND

CPU (Central Processing Unit) is the computing and control core of the computer system and the final execution unit for information processing and program running. A CPU can include one or more CPU cores and an uncore part.

A CPU core can typically include an MMU (Memory Management Unit), which can translate a virtual address into a physical address required for memory access.

The non-core part can include an IOMMU (Input/Output Memory Management Unit), which can be used to provide an address translation function for PCI (Peripheral Component Interconnect) devices, its function being similar to that of an MMU. The rate at which the IOMMU performs address translation directly affects the rate at which memory accesses are performed.

### SUMMARY

In view of this, the present specification provides a memory access method and apparatus, and input/output memory management unit.

Specifically, the present specification is implemented through the following technical solutions:

A memory access method applied to a computer system including a central processing unit (CPU), the CPU includes a CPU core and an input/output memory management unit (IOMMU), the method including:
receiving, by the IOMMU, a memory access request sent by a peripheral component interconnect (PCI) device, wherein the memory access request carries a virtual address;
searching, by the IOMMU, for a physical address corresponding to the virtual address in its input/output translation look-aside buffer (IOTLB);
in a case that no physical address corresponding to the virtual address is found, broadcasting, by the IOMMU, an address probing message to each CPU core, wherein the address probing message carries the virtual address;
searching, by the CPU core, for the physical address corresponding to the virtual address in its TLB in response to the address probing message, and sending an address response message to the IOMMU after finding the physical address corresponding to the virtual address, wherein the address response message carries the found physical address; and
receiving, by the IOMMU, the address response message sent by the CPU core, storing a mapping relationship between the physical address and the virtual address in its IOTLB, and performing memory access based on the physical address.

Optionally, it further includes:
in a case that no address response message is received, searching, by the IOMMU, for the physical address corresponding to the virtual address based on a process page table in a memory.

Optionally, the address probing message further carries an address space identifier, and searching, by the CPU core, for the physical address corresponding to the virtual address in its TLB includes:
searching, by the CPU core, in its TLB, for a mapping relationship, that matches the address space identifier, between the virtual address and the physical address; and
searching, by the CPU core, for the physical address corresponding to the virtual address in the found mapping relationship.

Optionally, broadcasting, by the IOMMU, an address probing message to each CPU core includes:
broadcasting, by the IOMMU, the address probing message to each CPU core based on the cache detection Snoop protocol.

A memory access method used in memory access of a computer system including a central processing unit (CPU), the CPU including a CPU core and an input/output memory management unit (IOMMU), the method being applied to the IOMMU, including:
receiving a memory access request sent by a peripheral component interconnect (PCI) device, wherein the memory access request carries a virtual address;
searching for a physical address corresponding to the virtual address in its input/output translation look-aside buffer (IOTLB);
in a case that no physical address corresponding to the virtual address is found, broadcasting an address probing message to each CPU core, wherein the address probing message carries the virtual address, so that the CPU core can search in its TLB for the physical address corresponding to the virtual address;
receiving an address response message sent by the CPU core in response to the address probing message, wherein the address response message carries the physical address corresponding to the virtual address found by the CPU core; and
storing the mapping relationship between the physical address and the virtual address in the IOTLB and performing memory access based on the physical address.

Optionally, it further includes:
in a case that no address response message is received, searching for the physical address corresponding to the virtual address based on a process page table in a memory.

Optionally, the address probing message further carries an address space identifier, so that the CPU core can search in its TLB for a mapping relationship, that matches the address space identifier, between the virtual address and the physical address, and searching for the physical address corresponding to the virtual address in the found mapping relationship.

Optionally, the broadcasting the address probing message to each CPU core includes:
broadcasting the address probing message to each CPU core based on the cache detection Snoop protocol.

A memory access apparatus used in memory access of a computer system, the computer system including a central processing unit (CPU), the CPU including a CPU core and an input/output memory management unit (IOMMU), the memory access apparatus including:
a request receiving unit, receiving a memory access request sent by a peripheral component interconnect (PCI) device, wherein the memory access request carries a virtual address;
an address search unit, searching for a physical address corresponding to the virtual address in an input/output translation look-aside buffer (IOTLB);
an address detection unit, in a case that no physical address corresponding to the virtual address is found, broadcasting an address probing message to each CPU core, wherein the address probing message carries the virtual address, so that the CPU core can search for the physical address corresponding to the virtual address in its TLB;
a response receiving unit, receiving an address response message sent by the CPU core in response to the address probing message, wherein the address response message carries a physical address corresponding to the virtual address found by the CPU core; and
a memory access unit, storing a mapping relationship between the physical address and the virtual address in the IOTLB and performing memory access based on the physical address.

An input-output memory management unit (IOMMU), configured to:
receive a memory access request sent by a peripheral component interconnect (PCI) device, wherein the memory access request carries a virtual address;
search for a physical address corresponding to the virtual address in an input/output translation look-aside buffer (IOTLB);
in a case that no physical address corresponding to the virtual address is found, broadcast an address probing message to each CPU core, wherein the address probing message carries the virtual address, so that the CPU core can search in its TLB for the physical address corresponding to the virtual address;
receive an address response message sent by the CPU core in response to the address probing message, wherein the address response message carries the physical address corresponding to the virtual address found by the CPU core; and
store a mapping relationship between the physical address and the virtual address in the IOTLB and perform memory access based on the physical address.

A central processing unit (CPU) including a CPU core and an input/output memory management unit (IOMMU),
wherein the IOMMU is used to receive a memory access request sent by a peripheral component interconnect (PCI) device, the memory access request carrying a virtual address;
the IOMMU searches for a physical address corresponding to the virtual address in its input/output translation look-aside buffer (IOTLB);
in a case that no physical address corresponding to the virtual address is found, broadcasting, by the IOMMU, an address probing message to each CPU core, wherein the address probing message carries the virtual address;
the CPU core searches for the physical address corresponding to the virtual address in its TLB in response to the address probing message, and sends an address response message to the IOMMU after finding the physical address corresponding to the virtual address, the address response message carrying the found physical address; and
the IOMMU receives the address response message sent by the CPU core, stores a mapping relationship between the physical address and the virtual address in its IOTLB, and performs memory access based on the physical address.

A computer system including the aforementioned central processing unit (CPU).

A computer-readable storage medium having a computer program stored thereon which, when executed by a central processing unit (CPU), implements the steps of the above method.

A computer-readable storage medium having a computer program stored thereon which, when executed by an input-output memory management unit (IOMMU), implements the steps in the above method.

By adopting the above technical solutions provided in the present specification, in a case that the PCI device accesses memory, the IOMMU can make full use of the TLB resources of the CPU core to realize TLB cache sharing between the CPU core and the IOMMU, which greatly reduces the additional overhead caused by the IOMMU's process page table query, effectively shortens the time of address translation in the case of IOTLB Miss, and improves the overall performance and efficiency of the CPU.

On the other hand, the above technical solutions provided in the present specification can be implemented based on the existing hardware IOMMU and cache consistency protocol, without the need for new hardware, with low cost and high feasibility.

### BRIEF DESCRIPTION OF THE DRAWINGS

FIG. 1 is a flowchart of a computer system illustrated in an exemplary embodiment of the present specification;

FIG. 2 is a flowchart of a memory access method illustrated in an exemplary embodiment of the present specification;

FIG. 3 is a flowchart of another memory access method illustrated in an exemplary embodiment of the present specification;

FIG. 4 is a flowchart of another memory access method illustrated in an exemplary embodiment of the present specification and

FIG. 5 is a block diagram of a memory access apparatus illustrated in an exemplary embodiment of the present specification.

### DETAILED DESCRIPTION

Detailed description will now be made to exemplary embodiments, examples of which are illustrated in the accompanying drawings. When the following description refers to the drawings, unless otherwise indicated, the same number in different drawings represent the same or similar element. The implementations described in the following exemplary embodiments do not represent all implementations consistent with the present specification. Rather, they are merely examples of apparatuses and methods consistent with some aspects of the present specification as recited in the appended claims.

The terms used in the present specification are for the purpose of describing particular embodiments only and are not intended to be limiting of the present specification. As used in the present specification and the appended claims, the singular forms “a,” “an,” and “said” are intended to include the plural forms as well, unless the context clearly indicates otherwise. It should be understood that the term “and/or” as used herein refers to and encompasses any and all possible combinations of one or more of the associated listed items.

It should be understood that although the terms “first”, “second”, “third”, etc. may be used in the present specification to describe various information, the information should not be limited to these terms. These terms are used only to distinguish information of the same type from one another. For example, first information may also be referred to as second information, and similarly, second information may also be referred to as first information, without departing from the scope of the present specification. The word “if” as used herein may be interpreted as “when” or “while” or “in response to determining,” depending on the context.

At present, an IOTLB (Input/Output Translation Lookaside Buffer) is usually set in the IOMMU of a computer system. In a case that a PCI device accesses memory based on a virtual address, the IOMMU can first query the IOTLB to check whether a physical address corresponding to the virtual address is cached in the IOTLB. In a case that the physical address corresponding to the virtual address is cached in the IOTLB (IOTLB Hit), memory access is performed based on the found physical address. In a case that the physical address corresponding to the virtual address is not cached in the IOTLB (IOTLB Miss), the physical address corresponding to the virtual address must be found based on the process page table in the memory. However, address translation based on the process page table (querying the physical address corresponding to the virtual address) often requires multiple memory accesses, which is time-consuming and greatly affects I/O performance.

The present specification provides a memory access method for a computer system, which can effectively shorten the time consumption of address conversion in the case of IOTLB Miss, thereby improving I/O performance and improving the overall performance and efficiency of the CPU.

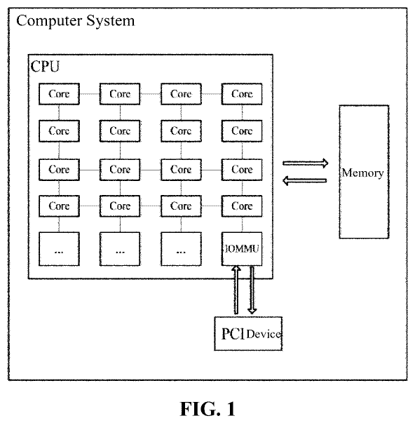

FIG. 1 is a flowchart of a computer system illustrated in an exemplary embodiment of the present specification.

Please referring to FIG. 1, the computer system can include a memory, a CPU, a PCI device, etc. The memory, the CPU and the PCI device can be connected via a bus.

Here, the CPU can include multiple CPU cores, and each CPU core can include an MMU for performing address translation. To improve the address translation rate, the MMU can store mapping relationships between virtual addresses and physical addresses in a TLB (Translation Look-aside Buffer) of the CPU core. TLB is a high-speed hardware buffer with a fast query rate and almost negligible latency.

In a case that the CPU core accesses the memory, the MMU is required to translate a virtual address into a physical address. The MMU usually queries the TLB first to check whether there is a physical address corresponding to the virtual address cached in the TBL. In a case that the physical address corresponding to the virtual address is cached in the TLB (TLB Hit), memory access can be performed based on the queried physical address. In a case that the physical address corresponding to the virtual address is not cached in the TLB (TLB Miss), the physical address corresponding to the virtual address must be queried based on the process page table in the memory to perform memory access. In addition, the MMU will store a mapping relationship between the queried virtual address and the physical address in the TLB for subsequent memory access.

The uncore part of the CPU can include one or more IOMMUs that can be used to provide an address translation function for the PCI device. The IOMMU is equipped with an IOTBL, which is similar to the TLB in the CPU core and can also be used to store mapping relationships between virtual addresses and physical addresses.

The PCI device can include: disk, GPU (Graphics Processing Unit), graphics card, sound card, etc. In a case that the PCI device accesses a memory, the IOMMU provides it with an address translation function.

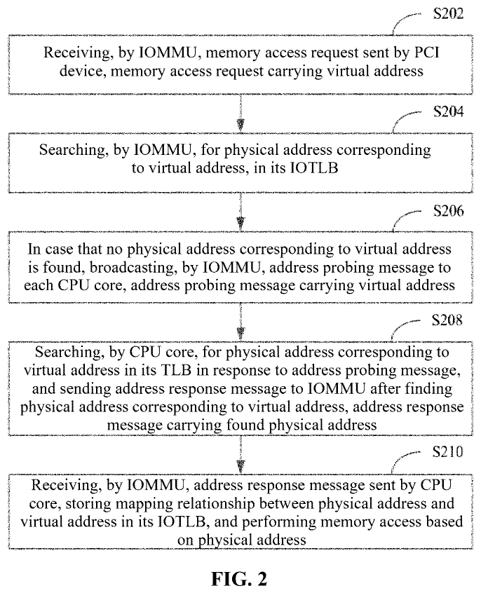

FIG. 2 is a flowchart of a memory access method illustrated in an exemplary embodiment of the present specification.

The memory access method can be applied in the computer system illustrated in FIG. 1, and includes the following steps:

Step 202: receiving, by an IOMMU, a memory access request sent by a PCI device, wherein the memory access request carries a virtual address.

In the present specification, an application program running in a CPU core can notify a PCI device to perform memory access.

For example, the application program notifies a disk to read user data from a memory and stores the read user data to the disk.

For another example, the application program notifies a GPU to read image data from a memory and processes the read image data.

In a case that the application program notifies the PCI device to access memory, it usually carries a virtual address of the relevant data in the memory.

After receiving a memory access notification sent by the application program, the PCI device can send a memory access request to the IOMMU, and carry the virtual address notified by the application program in the memory access request.

Step 204: searching, by the IOMMU, for a physical address corresponding to the virtual address, in its IOTLB.

Based on the aforementioned step 202, after receiving the memory access request sent by the PCI device, the IOMMU can first query the IOTLB. In a case that the physical address corresponding to the virtual address is found in the IOTLB (IOTLB Hit), the memory access may be performed based on the found physical address.

In a case that no physical address corresponding to the virtual address is found in the IOTLB (IOTLB Miss), step 206 can be performed.

Step 206: In a case that no physical address corresponding to the virtual address is found, broadcasting, by the IOMMU, an address probing message to each CPU core, wherein the address probing message carries the virtual address.

Based on the search result of the aforementioned step 204, in a case that no physical address corresponding to the virtual address is found in the IOTLB, the IOMMU broadcasts an address probing message to each CPU core.

Here, the address probing message can be broadcasted by the IOMMU through a bus. Under the architecture of multi-core CPU, a MESH network can be used to implement the bus design with lower latency.

The address probing message can be constructed based on the cache detection Snoop Protocol. The Snoop Protocol is a strategy for solving the cache consistency of multi-core processors in a hardware manner. Of course, in other examples, the address probing message can also be constructed based on other protocols, and the present specification does not impose any special limitation in this regard.

Step 208: searching, by the CPU core, for the physical address corresponding to the virtual address in its TLB in response to the address probing message, and sending an address response message to the IOMMU after finding the physical address corresponding to the virtual address, wherein the address response message carries the found physical address.

In the present specification, the CPU core can discover the address probing message by peeking at the bus. Then, it queries in its TLB whether a physical address corresponding to the virtual address is stored.

In a case that no physical address corresponding to the virtual address is stored in the TLB, the CPU core may send back a response message indicating that the physical address does not exist, that is, the response message does not carry the physical address.

In a case that the physical address corresponding to the virtual address is stored in the TLB, the CPU core can add the found physical address to the response message and send back the address response message to the IOMMU.

For example, the physical address can be added to the address response message and sent back to the IOMMU by extending the Snoop protocol.

Step 210: receiving, by the IOMMU, the address response message sent by the CPU core, storing a mapping relationship between the physical address and the virtual address in its IOTLB, and performing memory access based on the physical address.

Based on the aforementioned step 208, after receiving the address response message sent back by the CPU core, the IOMMU can extract the physical address therefrom, and then store a mapping relationship between the virtual address and the physical address in its IOTLB for use in subsequent memory accesses.

The IOMMU can access the memory based on the physical address. For example, data stored in the memory is accessed based on the physical address, and then the data is sent back to the PCI device.

It can be seen from the above description that in the present specification, in a case that the IOMMU does not store the physical address corresponding to the virtual address in its IOTLB, it broadcasts an address probing message to each CPU core to query whether the physical address corresponding to the virtual address is stored in the TLB of each CPU core. After the CPU core finds that the physical address corresponding to the virtual address is cached in the TLB, it can add the physical address to the address response message and send it back to the IOMMU. The IOMMU can then store the mapping relationship between the virtual address and the physical address and implement memory access.

By adopting the above technical solutions provided in the present specification, in a case that the PCI device accesses memory, the IOMMU can make full use of the TLB resources of the CPU core to realize TLB cache sharing between the CPU core and the IOMMU, which greatly reduces the additional overhead caused by the IOMMU's process page table query, effectively shortens the time of address translation in the case of IOTLB Miss, and improves the overall performance and efficiency of the CPU.

On the other hand, the above technical solutions provided in the present specification can be implemented based on the existing hardware IOMMU and cache consistency protocol, without the need for new hardware, with low cost and high feasibility.

The specific implementation process of the present specification is described in detail below from two aspects: the establishment of the TLB cache and the memory access of the PCI device.

### I. Establishment of TLB Cache

In the present specification, after an application program running on a certain CPU core is initialized, an operating system may generate an ASID (Address Space identifier (ID)) for the application program and bind the ASID to the process identifier (PID) of the application program. In addition, on the one hand, the ASID can be synchronized to management data of the IOMMU; on the other hand, the ASID can also be synchronized to a PCI device.

The application program can apply for user cache and get virtual addresses. On the one hand, the operating system can establish a process page table and record mapping relationships between virtual addresses and physical addresses in the process page table. On the other hand, the MMU of the CPU core may store the mapping relationships between the virtual addresses and the physical addresses in the TLB, for example, to generate TLB entries.

A TLB entry can include an ASID, a virtual address, a physical address, memory access permissions, a page type, etc.

Here, for different application programs, the same virtual address can be used, but the corresponding physical addresses must be different. Different application programs have different ASIDs. The mapping relationships between the virtual addresses and the physical addresses used by the application programs can be bound and stored with the ASIDs, thereby achieving address isolation between applications through the ASIDs.

Memory access permissions include read permissions and write permissions.

The page type is usually requested by the application program, such as 4K, 2M, 1G, etc.

For example, assuming that the application layer program A running on the CPU core 8 of the computer system is initialized and applies for user cache, the MMU 8 of the CPU core 8 generates a TLB entry in the TLB as shown in Table 1:

TABLE 1

| | |
|---|---|
| ASID | 3 |
| Virtual address | 0x800000 |
| Physical address | 0x200000 |
| Access permissions | Read |
| Page type | 2M |

Similarly, assuming that application program B also running on CPU core 8 is initialized and applies for user cache, the MMU8 of the CPU core 8 generates a TLB entry in the TLB as shown in Table 2:

TABLE 2

| | |
|---|---|
| ASID | 7 |
| Virtual address | 0x800000 |
| Physical address | 0x2000 |
| Access permissions | Read |
| Page type | 4K |

Please refer to Table 1 and Table 2. Application program A and Application B both use the same virtual address 0x800000, but their physical addresses are different. Address isolation is achieved through ASIDs.

### II. Memory Access of PCI Device

In the present specification, in a case that an application program requires a PCI device to process data, it can notify the PCI device to access a memory and send the virtual address, access permissions and data read length (size) required for the access to the PCI device. The PCI device can then initiate a memory access request to the IOMMU. The memory access request carries the aforementioned virtual address, access permissions, size, ASID synchronized during application initialization, and ID (Requestor ID) of the PCI device on the bus.

With reference to the implementation shown in FIG. 2, after receiving a memory access request sent by a PCI device, the IOMMU first queries the IOTLB to see whether there is a physical address that matches the above-mentioned ASID, virtual address, and access permissions.

For example, the IOMMU may first query table entries matching the ASID in the IOTLB, and then query in the table entries matching the ASID whether a physical address matching the virtual address and access permissions is cached.

Of course, the IOMMU is not required to match the ASID first, but can directly query the matching physical address in the IOTLB based on the ASID, virtual address, and access permissions.

In a case that a matching physical address is found in the IOTLB, memory access can be performed based on the physical address. For example, data of the size length specified in the access request can be read based on the physical address.

In a case that no matching physical address is found in the IOTLB, the IOMMU can broadcast an address probing message to each CPU core. The address probing message may carry the aforementioned ASID, virtual address, and access permissions.

After the CPU core receives the address probing message, the MMU of the CPU core queries in its TLB to see whether there is a physical address that matches the aforementioned ASID, virtual address, and access permissions.

Here, the MMU of the CPU core is similar to the IOMMU when performing physical address query. It can also first query table entries matching the ASID in the TLB, and then query in the table entries matching the ASID whether a physical address matching the above virtual address and access permissions is cached.

Of course, the MMU is not required to match the ASID first, but can directly query the matching physical address in the TLB based on the ASID, virtual address, and access permissions. The present specification does not impose any special limitation in this regard.

In a case that no matching physical address is found in the TLB, the CPU core can send back an address response message that does not carry the physical address.

In a case that a matching physical address is found in the TLB, the physical address can be added to the address response message and sent back to the IOMMU.

For example, the physical address, as well as the aforementioned ASID, virtual address, and access permissions, can be added to an address response message and sent back to the IOMMU.

After receiving the address response message, the IOMMU can store a mapping relationship between the physical address and the aforementioned ASID, virtual address and access permissions in the IOTLB for use in subsequent address translation.

In the present specification, the address probing message and the address response message can be constructed based on the Snoop protocol. In the process of implementing physical address probing based on the Snoop protocol, the Snoop Agent usually implements the forwarding of address probing messages and address response messages. For example, after receiving address response messages sent back by different CPU cores, the Snoop Agent filters out address response messages that do not carry physical addresses, and can also deduplicate address response messages carrying the same search results sent back by different CPU cores, for example, only send back an address response message carrying the aforementioned physical address to the IOMMU.

In the present specification, after receiving the address response message, the IOMMU can also perform memory access based on the physical address sent back, and after the access is completed, the read data can be sent to the PCI device based on the Requestor ID.

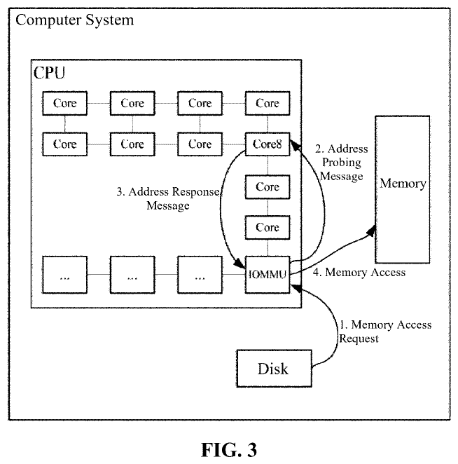

Take the TLB entries shown in Table 1 and Table 2 stored in the TLB of the aforementioned CPU core 8 as an example. Please referring to FIG. 3, assume that an application program A notifies a disk of a PCI device to store user data in a memory to the disk. The disk can send a memory access request to an IOMMU. The memory access request carries the ASID 3 synchronized after the application program is initialized, the virtual address 0x800000 notified by the application program, the access permissions of read, the access data length size, and the Requestor ID 06:00.01 of the disk on a bus.

The IOMMU queries its IOTLB and determines that a physical address corresponding to the ASID 3, virtual address 0x800000, and access permissions of read is not stored, and then broadcasts an address detection request to all CPU cores. Here, an MMU of CPU core 8 finds that the physical address 0x200000 corresponding to ASID 3, virtual address 0x800000, and access permissions of read is stored in its TLB, that is, the query hits table 1, and then constructs an address response message, which carries the physical address 0x200000, as well as ASID 3, virtual address 0x800000, and access permissions of read.

It is worth noting that although the virtual address in Table 2 is the same as the virtual address carried in the memory access request, due to the different ASIDs, the TLB entry shown in Table 2 will not be hit.

The CPU core 8 sends back an address response message to the IOMMU, and the IOMMU further stores the above-mentioned mapping relationship in the IOTLB, that is, generates the table entries shown in Table 1 in the IOTLB.

In addition, the IOMMU can also read user data from the memory based on the physical address, and then send the read user data to the disk based on the disk's Requestor ID 06:00.01 for disk storage.

As can be seen from the above description, by adopting the above technical solutions provided in the present specification, in a case that the PCI device accesses memory, the IOMMU can make full use of the TLB resources of the CPU core to realize TLB cache sharing between the CPU core and the IOMMU, which greatly reduces the additional overhead caused by the IOMMU's process page table query, effectively shortens the time of address translation in the case of IOTLB Miss, and improves the overall performance and efficiency of the CPU.

On the other hand, the above technical solutions provided in the present specification can be implemented based on the existing hardware IOMMU and cache consistency protocol, without the need for new hardware, with low cost and high feasibility.

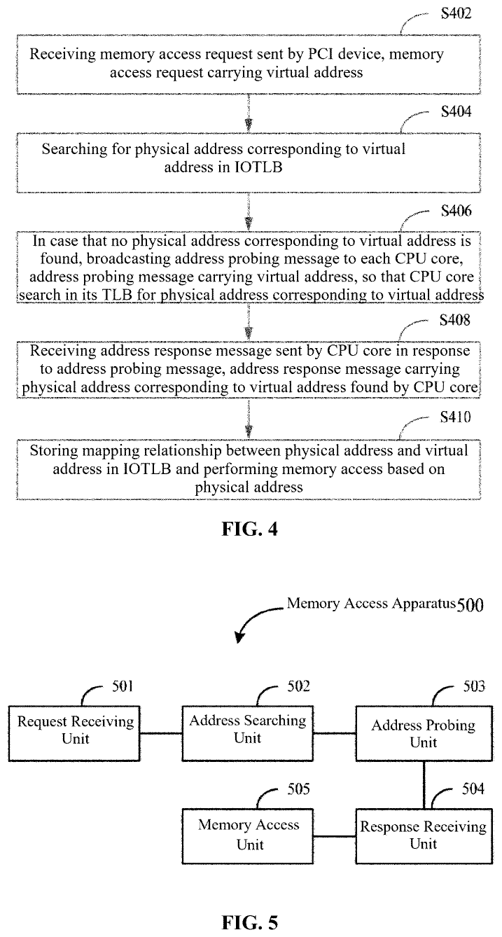

FIG. 4 is a flowchart of another memory access method illustrated in an exemplary embodiment of the present specification.

Please referring to FIG. 4, the memory access method can be applied in the IOMMU, and includes the following steps:

Step 402: receiving a memory access request sent by a PCI device, wherein the memory access request carries a virtual address.

Step 404: searching for a physical address corresponding to the virtual address, in its IOTLB.

Step 406: In a case that no physical address corresponding to the virtual address is found, broadcasting an address probing message to each CPU core, wherein the address probing message carries the virtual address, so that the CPU core can search in its TLB for the physical address corresponding to the virtual address.

Step 408: receiving an address response message sent by the CPU core in response to the address probing message, wherein the address response message carries the physical address corresponding to the virtual address found by the CPU core.

Step 410: storing a mapping relationship between the physical address and the virtual address in the IOTLB and performing memory access based on the physical address.

In the present embodiment, the implementation process of steps 402-410 can refer to the embodiments shown in the aforementioned FIGS. 2 and 3, and the present specification will not repeat it here.

Corresponding to the above-mentioned embodiments of the memory access method, the present specification also provides an embodiment of a memory access apparatus.

The memory access apparatus of the present specification may be applied to the IOMMU shown in FIG. 1. Please referring to FIG. 5, the memory access apparatus 500 can include:
here, a request receiving unit 501, receiving a memory access request sent by a peripheral component interconnect (PCI) device, wherein the memory access request carries a virtual address;
an address search unit 502, searching for a physical address corresponding to the virtual address in an input/output translation look-aside buffer (IOTLB);
an address detection unit 503, in a case that no physical address corresponding to the virtual address is found, broadcasting an address probing message to each CPU core, wherein the address probing message carries the virtual address, so that the CPU core can search for the physical address corresponding to the virtual address in its TLB;
a response receiving unit 504, receiving an address response message sent by the CPU core in response to the address probing message, wherein the address response message carries a physical address corresponding to the virtual address found by the CPU core; and
a memory access unit 505, storing a mapping relationship between the physical address and the virtual address in the IOTLB and performing memory access based on the physical address.

Optionally, in a case that no address response message is received, the memory access unit 505 searches for the physical address corresponding to the virtual address based on the process page table in the memory, stores a mapping relationship between the physical address and the virtual address in the IOTLB and performs memory access based on the physical address.

Optionally, the address probing message further carries an address space identifier, so that the CPU core can search in its TLB for a mapping relationship, that matches the address space identifier, between the virtual address and the physical address; and the CPU core searches for the physical address corresponding to the virtual address in the found mapping relationship.

Optionally, the address detection unit 503 broadcasts an address probing message to each CPU core based on the Snoop protocol.

The implementation process of the function and effect of each unit in the above-mentioned apparatus is specifically described in the implementation process of the corresponding steps in the above-mentioned method and will not be repeated here.

As for the apparatus embodiment, since it basically corresponds to the method embodiment, the relevant parts can refer to the partial description of the method embodiment. The apparatus embodiments described above are merely illustrative, wherein the units described as separate components may or may not be physically separated, and the components displayed as units may or may not be physical units, that is, they may be located in one place or distributed over multiple network units. Some or all of the modules can be selected according to actual requirements to achieve the purpose of the solution in the present specification. A person skilled in the art can understand and implement the present invention without any inventive effort.

The systems, devices, modules or units described in the above embodiments may be implemented by computer chips or entities, or by products with certain functions. A typical implementation device is a computer, which may be in the specific form of a personal computer, a laptop computer, a cellular phone, a camera phone, a smart phone, a personal digital assistant, a media player, a navigation device, an email sending and receiving device, a game console, a tablet computer, a wearable device, or a combination of any several of these devices.

Corresponding to the embodiment of the aforementioned memory access method, the present specification also provides an IOMMU, which is configured to:
search for a physical address corresponding to the virtual address, in its IOTLB.
in a case that no physical address corresponding to the virtual address is found, broadcast an address probing message to each CPU core, wherein the address probing message carries the virtual address, so that the CPU core can search in its TLB for the physical address corresponding to the virtual address;
receive an address response message sent by the CPU core in response to the address probing message, wherein the address response message carries the physical address corresponding to the virtual address found by the CPU core; and
store a mapping relationship between the physical address and the virtual address in the IOTLB and perform memory access based on the physical address.

Optionally, in a case that no address response message is received, search for the physical address corresponding to the virtual address based on the process page table in the memory.

Optionally, the address probing message further carries an address space identifier, so that the CPU core can search in its TLB for a mapping relationship, that matches the address space identifier, between the virtual address and the physical address, and searching for the physical address corresponding to the virtual address in the found mapping relationship.

Optionally, the broadcasting the address probing message to each CPU core includes:
broadcasting the address probing message to each CPU core based on the Snoop protocol.

Corresponding to the embodiment of the aforementioned memory access method, the present specification also provides a CPU including a CPU core and an IOMMU.

Here, the IOMMU is used to receive a memory access request sent by a PCI device, wherein the memory access request carries a virtual address;
searching, by the IOMMU, for a physical address corresponding to the virtual address, in its IOTLB;
in a case that no physical address corresponding to the virtual address is found, the IOMMU broadcasts an address probing message to each CPU core, wherein the address probing message carries the virtual address;
the CPU core searches for the physical address corresponding to the virtual address in its TLB in response to the address probing message, and sends an address response message to the IOMMU after finding the physical address corresponding to the virtual address, wherein the address response message carries the found physical address; and
the IOMMU receives the address response message sent by the CPU core, stores a mapping relationship between the physical address and the virtual address in its IOTLB, and performs memory access based on the physical address.

Optionally, in a case that no address response message is received, the IOMMU searches for the physical address corresponding to the virtual address based on the process page table in the memory.

Optionally, the address probing message further carries an address space identifier, and searching, by the CPU core, for the physical address corresponding to the virtual address in its TLB includes:
searching, by the CPU core, in its TLB, for a mapping relationship, that matches the address space identifier, between the virtual address and the physical address; and
searching, by the CPU core, for the physical address corresponding to the virtual address in the found mapping relationship.

Optionally, broadcasting, by the IOMMU, an address probing message to each CPU core includes:
broadcasting, by the IOMMU, the address probing message to each CPU core based on the cache detection Snoop protocol.

Corresponding to the aforementioned embodiment of the memory access method, the present specification also provides a computer system, including the CPU described in the aforementioned embodiment of the present specification.

Corresponding to the embodiment of the aforementioned memory access method, the present specification also provides a computer-readable storage medium having a computer program stored thereon which, when executed by a CPU, implements the following steps:
receiving, by an IOMMU, a memory access request sent by a PCI device, wherein the memory access request carries a virtual address;
searching, by the IOMMU, for a physical address corresponding to the virtual address, in its IOTLB;
in a case that no physical address corresponding to the virtual address is found, broadcasting, by the IOMMU, an address probing message to each CPU core, wherein the address probing message carries the virtual address;
searching, by the CPU core, for the physical address corresponding to the virtual address in its TLB in response to the address probing message, and sending an address response message to the IOMMU after finding the physical address corresponding to the virtual address, wherein the address response message carries the found physical address; and
receiving, by the IOMMU, the address response message sent by the CPU core, storing a mapping relationship between the physical address and the virtual address in its IOTLB, and performing memory access based on the physical address.

Optionally, it further includes:
in a case that no address response message is received, searching, by the IOMMU, for the physical address corresponding to the virtual address based on the process page table in the memory.

Optionally, the address probing message further carries an address space identifier, and searching, by the CPU core, for the physical address corresponding to the virtual address in its TLB includes:
searching, by the CPU core, in its TLB, for a mapping relationship, that matches the address space identifier, between the virtual address and the physical address; and
searching, by the CPU core, for the physical address corresponding to the virtual address in the found mapping relationship.

Optionally, broadcasting, by the IOMMU, an address probing message to each CPU core includes:
broadcasting, by the IOMMU, the address probing message to each CPU core based on the cache detection Snoop protocol.

Corresponding to the embodiment of the aforementioned memory access method, the present specification also provides a computer-readable storage medium having a computer program stored thereon which, when executed by a IOMMU, implements the following steps:
receive a memory access request sent by a peripheral component interconnect (PCI) device, wherein the memory access request carries a virtual address;
search for a physical address corresponding to the virtual address in an input/output translation look-aside buffer (IOTLB);
in a case that no physical address corresponding to the virtual address is found, broadcast an address probing message to each CPU core, wherein the address probing message carries the virtual address, so that the CPU core can search in its TLB for the physical address corresponding to the virtual address;
receive an address response message sent by the CPU core in response to the address probing message, wherein the address response message carries the physical address corresponding to the virtual address found by the CPU core; and
store a mapping relationship between the physical address and the virtual address in the IOTLB and perform memory access based on the physical address.

Optionally, it further includes:
in a case that no address response message is received, searching for the physical address corresponding to the virtual address based on the process page table in the memory.

Optionally, the address probing message further carries an address space identifier, so that the CPU core can search in its TLB for a mapping relationship, that matches the address space identifier, between the virtual address and the physical address, and search for the physical address corresponding to the virtual address in the found mapping relationship.

Optionally, the broadcasting the address probing message to each CPU core includes:
broadcasting the address probing message to each CPU core based on the Snoop protocol.

Specific embodiments of the present specification are described above. Other embodiments are also within the scope of the appended claims. In some cases, the actions or steps recited in the claims may be performed in a different order than in the embodiments and still achieve the desired results. In addition, the processes depicted in the drawings do not necessarily require the specific order shown or the sequential order to achieve the desired results. In certain embodiments, multitasking and parallel processing are also possible or may be advantageous.

The above only describes preferred embodiments of the present specification and is not intended to limit the present specification. Any modifications, equivalent substitutions, improvements, etc. made within the spirit and principles of the present specification should be included in the scope of protection of the present specification.

1. A memory access method applied to a computer system, the computer system comprising a central processing unit (CPU), the CPU comprising a CPU core and an input/output memory management unit (IOMMU), the method comprising:
receiving, by the IOMMU, a memory access request sent by a peripheral component interconnect (PCI) device, the memory access request carrying a virtual address;
searching, by the IOMMU, for a physical address corresponding to the virtual address in its input/output translation look-aside buffer (IOTLB);
in a case that no physical address corresponding to the virtual address is found, broadcasting, by the IOMMU, an address probing message to each CPU core, the address probing message carrying the virtual address;
searching, by the CPU core, for the physical address corresponding to the virtual address in its TLB in response to the address probing message, and sending an address response message to the IOMMU after finding the physical address corresponding to the virtual address, the address response message carrying the found physical address; and
receiving, by the IOMMU, the address response message sent by the CPU core, storing a mapping relationship between the physical address and the virtual address in its IOTLB, and performing memory access based on the physical address.

2. The method of claim 1, further comprising:
in a case that no address response message is received, searching, by the IOMMU, for the physical address corresponding to the virtual address based on a process page table in a memory.

3. The method of claim 1, wherein the address probing message further carries an address space identifier, and searching, by the CPU core, for the physical address corresponding to the virtual address in its TLB comprises:
searching, by the CPU core, for a mapping relationship, that matches the address space identifier, between the virtual address and the physical address, in its TLB; and
searching, by the CPU core, for the physical address corresponding to the virtual address in the found mapping relationship.

4. The method of claim 1, wherein the broadcasting, by the IOMMU, an address probing message to each CPU core comprises:
broadcasting, by the IOMMU, the address probing message to each CPU core based on the cache detection Snoop protocol.

5. A memory access method for memory access of a computer system, the computer system comprising a central processing unit (CPU), the CPU comprising a CPU core and an input/output memory management unit (IOMMU), the method being applied to the IOMMU, comprising:
receiving a memory access request sent by a peripheral component interconnect (PCI) device, the memory access request carrying a virtual address;
searching for a physical address corresponding to the virtual address in an input/output translation look-aside buffer (IOTLB);
in a case that no physical address corresponding to the virtual address is found, broadcasting an address probing message to each CPU core, the address probing message carrying the virtual address, so that the CPU core can search in its TLB for the physical address corresponding to the virtual address;
receiving an address response message sent by the CPU core in response to the address probing message, the address response message carrying the physical address corresponding to the virtual address found by the CPU core; and
storing the mapping relationship between the physical address and the virtual address in the IOTLB and performing memory access based on the physical address.

6. The method of claim 5, further comprising:
in a case that no address response message is received, searching for the physical address corresponding to the virtual address based on a process page table in a memory.

7. The method of claim 5, wherein the address probing message further carries an address space identifier, so that the CPU core can search in its TLB for a mapping relationship, that matches the address space identifier, between a virtual address and the physical address, and search for the physical address corresponding to the virtual address in the found mapping relationship.

8. The method of claim 5, wherein the broadcasting the address probing message to each CPU core comprises:
broadcasting the address probing message to each CPU core based on the cache detection Snoop protocol.

9. An input-output memory management unit (IOMMU) configured to:
receive a memory access request sent by a peripheral component interconnect (PCI) device, the memory access request carrying a virtual address;
search for a physical address corresponding to the virtual address in an input/output translation look-aside buffer (IOTLB);
in a case that no physical address corresponding to the virtual address is found, broadcast an address probing message to each CPU core, the address probing message carrying the virtual address, so that the CPU core can search in its TLB for the physical address corresponding to the virtual address;
receive an address response message sent by the CPU core in response to the address probing message, wherein the address response message carries the physical address corresponding to the virtual address found by the CPU core; and
store a mapping relationship between the physical address and the virtual address in the IOTLB and perform memory access based on the physical address.

10-13. (canceled)

14. The input-output memory management unit (IOMMU) of claim 9, further configured to:
in a case that no address response message is received, searching for the physical address corresponding to the virtual address based on a process page table in a memory.

15. The input-output memory management unit (IOMMU) of claim 9, wherein the address probing message further carries an address space identifier, and the CPU core searching in its TLB for the physical address corresponding to the virtual address comprises:
searching, by the CPU core, for a mapping relationship, that matches the address space identifier, between the virtual address and the physical address, in its TLB; and
searching, by the CPU core, for the physical address corresponding to the virtual address in the found mapping relationship.

16. The method of claim 9, wherein the broadcasting the address probing message to each CPU core comprises:
broadcasting the address probing message to each CPU core based on the cache detection Snoop protocol.
